(19) United States
(12) Patent Application Publication
(10) Pub. No.: US 2007/0085950 A1
(43) Pub. Date: Apr. 19, 2007

(54) Light guide plate and diffusion plate with cholesteric liquid crystal layer and backlight module having the same

(76) Inventors: Chen-Ze Hu, Tainan (TW); Shen-Yin Tsai, Tainan (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/529,348

(22) Filed: Sep. 29, 2006

(30) Foreign Application Priority Data
Oct. 17, 2005 (TW) 094136205

(51) Int. Cl. G02F 1/1335

(52) U.S. Cl. 349/115

(57) ABSTRACT

The present invention relates to a light guide plate and a diffusion plate. A cholesteric liquid crystal (CLC) layer is disposed on a surface of the light guide plate or the diffusion plate to output a single polarized light with extremely low light-intensity loss, thus having an effect of enhancing the brightness of the output light. The structures of the light guide plate and the diffusion plate are simple, and the manufacturing cost of the light guide plate and the diffusion plate can be reduced.

### BACKGROUND OF THE INVENTION

1. Field of the Invention

The present invention relates to a light guide plate, a diffusion plate and a backlight module having the same. More particularly, the present invention relates to a light guide plate and a diffusion plate with a cholesteric liquid crystal (CLC) layer for enhancing the brightness of light, and a backlight module having the same.

2. Description of the Related Art

FIG. 1 shows a schematic view of a conventional liquid crystal display (LCD). The LCD 1 comprises a side-edge backlight module. The LCD 1 comprises a light source 11, a light guide plate 12, a reflection sheet 13, a polarizing plate 14, and a liquid crystal element 15. The-light source 11 is used for emitting light. The light source 11 can be a plurality of cold cathode fluorescent lamps (CCFLs) or a plurality of light-emitting diodes (LEDs). The light guide plate 12 has an upper surface 121, a lower surface 122, and a side surface 123, wherein the side surface 123 is an illuminated surface for receiving the light from the light source 11. The lower surface 122 of the light guide plate 12 has a plurality of reflection points 124 for reflecting a portion of the light from the light source 11. The light that is not reflected by the reflection points 124 is reflected by the reflection sheet 13 disposed below the light guide plate 12. The upper surface 121 is a light-emitting surface for transmitting light to the polarizing plate 14, so as to perform the light polarization screening. After that, the light enters the liquid crystal element 15.

The LCD 1 has a disadvantage that a loss of approximately 50% intensity of the light emitted by the light source 11 may occur before the light enters the liquid crystal element 15. Therefore, the intensity of light output is lower than the intensity of light emitted by the light source 11, thus leading to an energy loss that causes a low brightness of the LCD 1.

The ROC (Taiwan) Patent Publication Nos. 507086, 450013, 454098 and 459153 etc., disclose various backlight modules capable of enhancing the brightness of the output light. However, because they use a complicated geometric structure, these backlight modules cannot be easily manufactured and have a high cost.

Therefore, it is necessary to provide a light guide plate and a diffusion plate to solve the above problems.

### SUMMARY OF THE INVENTION

The object of the present invention is to provide a light guide plate and a diffusion plate with a CLC layer, for outputting a single polarized light with extremely low light-intensity loss, thus having an effect of enhancing the brightness of the output light. The structures of the light guide plate and the diffusion plate are simple, and the manufacturing cost of the light guide plate and the diffusion plate can be reduced.

### BRIEF DESCRIPTION OF THE DRAWINGS

FIG. 1 is a schematic view of a conventional LCD;

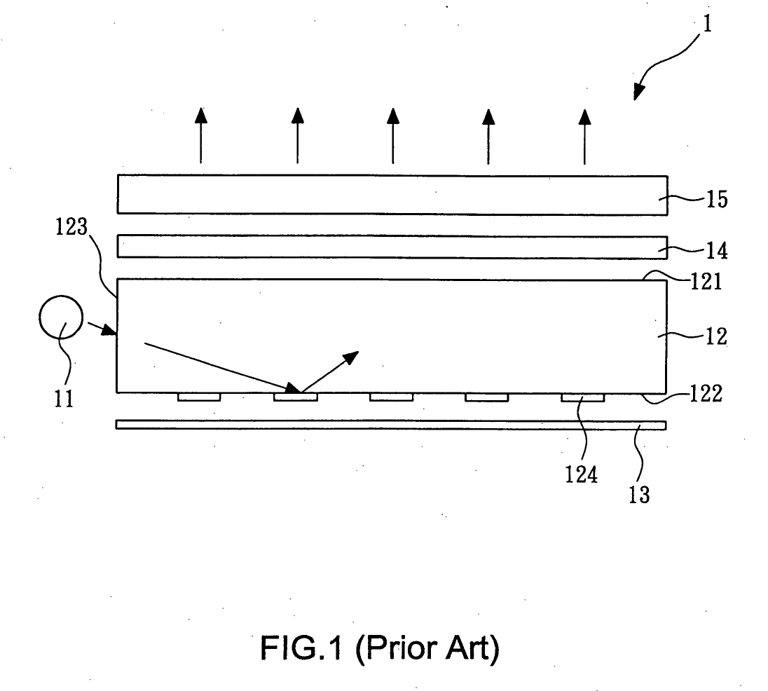

FIG. 2 is a schematic view of a side-edge backlight module according to the first embodiment of the present invention; and

FIG. 3 is a schematic view of a direct-type backlight module according to the second embodiment of the present invention.

### DETAILED DESCRIPTION OF THE INVENTION

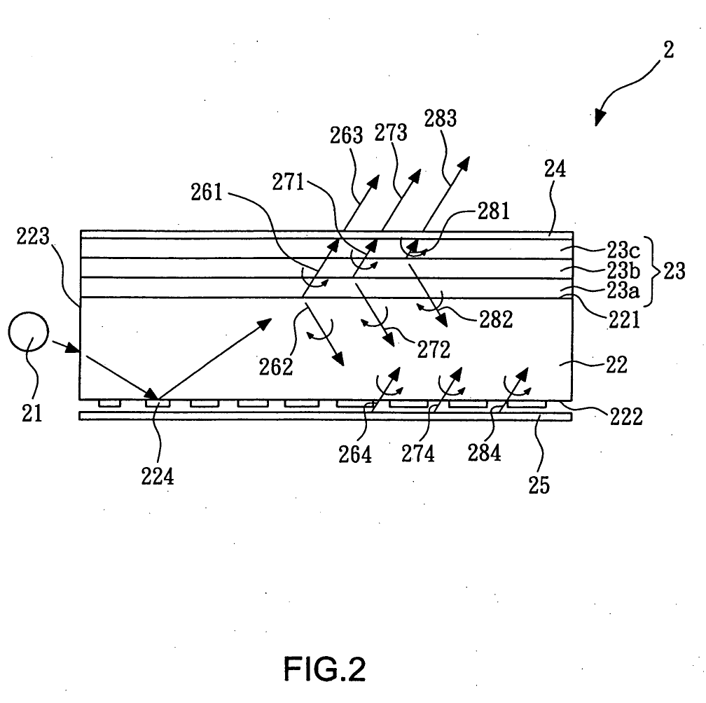

FIG. 2 shows a schematic view of a side-edge backlight module according to the first embodiment of the present invention. The side-edge backlight module 2 is applied to a display (for example, an LCD). The side-edge backlight module 2 comprises a light source 21, a light guide plate body 22, at least one cholesteric liquid crystal (CLC) layer 23, a quarter-wave retardation 24, and a reflection sheet 25.

The light source 21 is used for emitting light. In the present embodiment, the light source is a plurality of CCFLs. It should be understood that the light source 21 can also be a plurality of LEDs.

The light guide plate 22 has an upper surface 221, a lower surface 222, and a side surface 223, wherein the side surface 223 is an illuminated surface for receiving the light from the light source 21. The lower surface 222 has a plurality of reflection points 224 for reflecting the light.

The CLC layer 23 is disposed on the upper surface 221 of the light guide plate body 22 by attaching or coating. The number of the CLC layers 23 is designed in accordance with the light from the light source 21 and must cover all the wavelength sections of the light. In the present embodiment, the light source 21 is CCFLs. The light emitted by the light source 21 can be divided into three wavelength sections (a first wavelength section, a second wavelength section, and a third wavelength section). Due to the narrow frequency spectrum characteristic of the CLC layer 23, the CLC layer 23 has three layers including a first CLC layer 23a, a second CLC layer 23b, and a third CLC layer 23c. The refraction property of the first CLC layer 23a corresponds to the first wavelength section of the light, i.e., the first CLC layer 23a is used to reflect light of the first wavelength section. The second CLC layer 23b is disposed on the first CLC layer 23a and the refraction property thereof corresponds to the second wavelength section of the light, i.e., the second CLC layer 23b is used to reflect light of the second wavelength section. The third CLC layer 23c is disposed on the second CLC layer 23b and the refraction property thereof corresponds to the third wavelength section of the light, i.e., the third CLC layer 23c is used to reflect light of the third wavelength section.

The quarter-wave retardation 24 is disposed on the third CLC layer 23c by attaching or coating. The quarter-wave retardation 24 is a polymer film with a birefringence property. When a light passes through this film, the phase difference of the light has a quarter-period difference between the directions of the ordinary axis and extraordinary axis of the polymer film.

The reflection sheet 25 is disposed below the light guide plate body 22 for reflecting light and changing the polarization direction of the light.

The operating manner of the side-edge backlight module 2 is described as follows. The light emitted by the light source 21 is reflected by the reflection points 224 after entering the light guide plate body 22 through the side surface 223. The light of the first wavelength section, after entering the first CLC layer 23a, is divided into two orthogonal circular polarized lights, namely a left-circular polarized light (for example, a light 261) and a right-circular polarized light (for example, a light 262). In the present embodiment, the light 261 (left-circular polarized light) passes through the first CLC layer 23a, the second CLC layer 23b, and the third CLC layer 23c, and then passes through the quarter-wave retardation 24, so as to form a linear polarized light (for example, a light 263).

The light 262 (right-circular polarized light) of the first wavelength section is reflected to the light guide plate body 22, and then reflected by the reflection sheet 25 and changes into a left-circular polarized light (for example, a light 264). The light 264, like the light 261, passes through the first CLC layer 23a, the second CLC layer 23b, and the third CLC layer 23c, and then enters the quarter-wave retardation 24.

Similarly, the light of the second wavelength section, after entering the second CLC layer 23b, is divided into two orthogonal circular polarized lights, namely a left-circular polarized light (for example, a light 271) and a right-circular polarized light (for example, a light 272). In the present embodiment, the light 271 (left-circular polarized light) passes through the second CLC layer 23b and the third CLC layer 23c, and then passes through the quarter-wave retardation 24, so as to form a linear polarized light (for example, a light 273).

The light 272 (right-circular polarized light) of the second wavelength section is reflected to the light guide plate body 22, and then reflected by the reflection sheet 25 and changes into a left-circular polarized light (for example, a light 274). The light 274, like the light 271, passes through the first CLC layer 23a, the second CLC layer 23b, and the third CLC layer 23c, and then enters the quarter-wave retardation 24.

The light of the third wavelength section, after entering the third CLC layer 23c, is divided into two orthogonal circular polarized lights namely a left-circular polarized light (for example, a light 281) and a right-circular polarized light (for example, a light 282). In the present embodiment, the light 281 (left-circular polarized light) passes through the third CLC layer 23c and then passes through the quarter-wave retardation 24, so as to form a linear polarized light (for example, a light 283).

The light 282 (right-circular polarized light) of the third wavelength section is reflected to the light guide plate body 22, and then reflected by the reflection sheet 25 and changes into a left-circular polarized light (for example, a light 284). The light 284, like the light 281, passes through the first CLC layer 23a, the second CLC layer 23b, and the third CLC layer 23c, and then enters the quarter-wave retardation 24.

Therefore, according to the present invention, the side-edge backlight module 2 outputs a single polarized light with extremely low light-intensity loss, thus having an effect of enhancing the brightness of the output light. The structure of the side-edge backlight module 2 is simple, and the manufacturing cost of the side-edge backlight module 2 can be reduced.

Furthermore, in another application, if the light source 21 is a plurality of LEDs of three primary colors; the refraction properties of the CLC layers respectively correspond to the wavelengths of the LEDs.

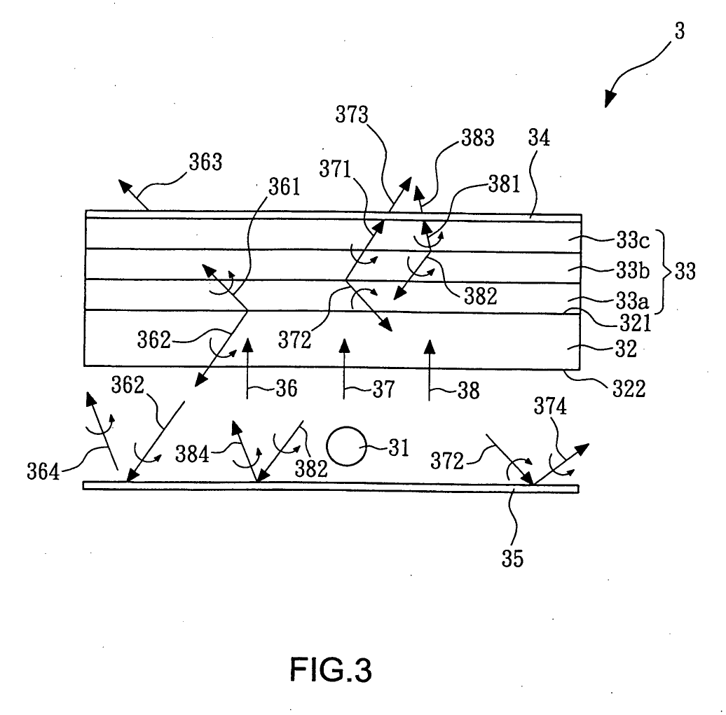

FIG. 3 shows a schematic view of a direct-type backlight module according to the second embodiment of the present invention. The direct-type backlight module 3 is applied to a display (for example, an LCD). The direct-type backlight module 3 includes a light source 31, a diffusion plate body 32, at least one CLC layer 33, a quarter-wave retardation 34, and a reflection sheet 35.

The light source 31 is used for emitting light. In the present embodiment, the light source is a plurality of CCFLs. It should be understood that the light source 31 can also be a plurality of LEDs.

The diffusion plate 32 has an upper surface 321 and a lower surface 322, wherein the lower surface 322 is an illuminated surface for receiving the light from the light source 31.

The CLC layer 33 is disposed on the upper surface 321 of the diffusion plate body 32 by attaching or coating. The number of the CLC layers 33 is designed in accordance with the light from the light source 31 and must cover all the wavelength sections of the light. In the present embodiment, the light source 31 is CCFLs. The light emitted by the light source 31 can be divided into three wavelength sections including a first wavelength section (for example, a light 36), a second wavelength section (for example, a light 37), and a third wavelength section (for example, a light 38). Due to the narrow frequency spectrum characteristic of the CLC layer 33, the CLC layer 33 has three layers including a first CLC layer 33a, a second CLC layer. 33b, and a third CLC layer 33c. The refraction property of the first CLC layer 33a corresponds to the light 36, i.e., the first CLC layer 33a is used to reflect the light 36. The second CLC layer 33b is disposed on the first CLC layer 33a and the refraction property thereof corresponds to the light 37, i.e., the second CLC layer 33b is used to reflect the light 37. The third CLC layer 33c is disposed on the second CLC layer 33b and the refraction property thereof corresponds to the light 38, i.e., the third CLC layer 33c is used to reflect the light 38.

The quarter-wave retardation 34 is disposed on the third CLC layer 33c by attaching or coating. The reflection sheet 35 is disposed below the diffusion plate body 32 for reflecting light and changing the polarization direction of the light.

The operating manner of the direct-type backlight module 3 is described as follows. After the light emitted by the light source 31 passes through the diffusion plate body 32, the light 36 of the first wavelength section enters the first CLC layer 33a. Then, the light 36 is divided into two orthogonal circular polarized lights, namely a left-circular polarized light (for example, a light 361) and a right-circular polarized light (for example, a light 362). In the present embodiment, the light 361 (left-circular polarized light) passes through the first CLC layer 33a, the second CLC layer 33b, and the third CLC layer 33c, and then passes through the quarter-wave retardation 34, so as to form a linear polarized light (for example, a light 363).

The light 362 (right-circular polarized light) is reflected to the diffusion plate body 32, and then reflected by the reflection sheet 35 and changes into a left-circular polarized light (for example, a light 364). The light 364, like the light 361, passes through the first CLC layer 33a, the second CLC layer 33b, and the third CLC layer 33c, and then enters the quarter-wave retardation 34.

Similarly, the light 37 of the second wavelength section, after entering the second CLC layer 33b, is divided into two orthogonal circular polarized lights, namely a left-circular polarized light.(for example, a light 371) and a right-circular polarized light (for example, a light 372). In the present embodiment, the light 371 (left-circular polarized light) passes through the second CLC layer 33b and the third CLC layer 33c, and then passes through the quarter-wave retardation 34, so as to form, a linear polarized light (for example, a light 373).

The light 372 (right-circular polarized light) is reflected to the diffusion plate body 32, and then reflected by the reflection sheet 35 and changes into a left-circular polarized light (for example, a light 374). The light 374, like the light 371, passes through the first CLC layer 33a, the second CLC layer 33b, and the third CLC layer 33c, and then enters the quarter-wave retardation 34.

The light 38 of the third wavelength section, after entering the third CLC layer 33c, is divided into two orthogonal circular polarized lights, namely a left-circular polarized light (for example, a light 381) and a right-circular polarized light (for example, a light 382). In the present embodiment, the light 381 (left-circular polarized light) passes through the third CLC layer 33c, and then passes through the quarter-wave retardation 34, so as to form a linear polarized light (for example, a light 383).

The light 382 (right-circular polarized light) is reflected to the diffusion plate body 32, and then reflected by the reflection sheet 35 and changes into a left-circular polarized light (for example, a light 384). The light 384, like the light 381, passes through the first CLC layer. 33a, the second CLC layer 33b, and the third CLC layer 33c, and then enters the quarter-wave retardation 34.

Therefore, according to the present invention, the direct-type backlight module 3 outputs a single polarized light with extremely low light-intensity loss, thus having an effect of enhancing the brightness of the output light. The structure of the direct-type back-light module 3 is simple, and the manufacturing cost of the direct-type backlight module 3 can be reduced.

Furthermore, in another application, if the light source 31 is a plurality of LEDs of three primary colors, the refraction properties of the CLC layers respectively correspond to the wavelengths of the LEDs.

While several embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. A light guide plate, comprising:
a body, having an upper surface, a lower surface and a side surface, wherein the side surface is an illuminated surface for receiving a light from a light source;
at least one cholesteric liquid crystal (CLC) layer, disposed on the upper surface of the body, for dividing the light into a first circular polarized light and a second circular polarized light, wherein the first circular polarized light passes through the CLC layer, and the second circular polarized light is reflected; and
a quarter-wave retardation, disposed on the CLC layer, for converting the first circular polarized light into a linear polarized light.

2. The light guide plate as claimed in claim 1, wherein the lower surface of the body further comprises a plurality of reflection points for reflecting the light.

3. The light guide plate as claimed in claim 1, wherein the CLC layer is attached to the upper surface of the body.

4. The light guide plate as claimed in claim 1, wherein the quarter-wave retardation is attached to the CLC layer.

5. The light guide plate as claimed in claim 1, wherein the CLC layer is coated on the upper surface of the body.

6. The light guide plate as claimed in claim 1, wherein the light guide plate comprises at least three CLC layers.

7. A side-edge backlight module, comprising:
a light source, for emitting light;
a light guide plate body, having an upper surface, a lower surface and a side surface, wherein the side surface is an illuminated surface for receiving the light from the light source;
at least one CLC layer, disposed on the upper surface of the light guide plate body, for dividing the light into a first circular polarized light and a second circular polarized light, wherein the first circular polarized light passes through the CLC layer, and the second circular polarized light is reflected;
a quarter-wave retardation, disposed on the CLC layer, for converting the circular polarized light into a linear polarized light; and
a reflection sheet, disposed below the light guide plate body, for reflecting the light and changing the polarization direction of the light.

8. The side-edge backlight module as claimed in claim 7, wherein the lower surface of the light guide plate body further comprises a plurality of reflection points for reflecting the light.

9. The side-edge backlight module as claimed in claim 7, wherein the CLC layer is attached to the upper surface of the light guide plate body.

10. The side-edge backlight module as claimed in claim 7, wherein the quarter-wave retardation is attached to the CLC layer.

11. The side-edge backlight module as claimed in claim 7, wherein the CLC layer is coated on the upper surface of the light guide plate body.

12. The side-edge backlight module as claimed in claim 7, wherein the side-edge backlight module comprises at least three CLC layers.

13. The side-edge backlight module as claimed in claim 7, wherein the light source is a plurality of cold cathode fluorescent lamps (CCFLs).

14. The side-edge backlight module as claimed in claim 7, wherein the light source is a plurality of light-emitting diodes (LEDs).

15. A diffusion plate, comprising:
a body, having an upper surface and a lower surface, wherein the lower surface is an illuminated surface for receiving the light from a light source;
at least one CLC layer, disposed on the upper surface of the body, for dividing the light into a first circular polarized light and a second circular polarized light, wherein the first circular polarized light passes through the CLC layer, and the second circular polarized light is reflected; and
a quarter-wave retardation, disposed on the CLC layer, for converting the first circular polarized light into a linear polarized light.

16. The diffusion plate as claimed in claim 15, wherein the CLC layer is attached to the upper surface of the body.

17. The diffusion plate as claimed in claim 15, wherein the quarter-wave retardation is attached to the CLC layer.

18. The diffusion plate as claimed in claim 15, wherein the CLC layer is coated on the upper surface of the body.

19. The diffusion plate as claimed in claim 15, wherein the diffusion plate comprises at least three CLC layers.

20. A direct-type backlight module, comprising:
a light source, for emitting light;
a diffusion plate body, having an upper surface and a lower surface, disposed above the light source, wherein the lower surface is an illuminated surface for receiving the light from the light source;
at least one CLC layer, disposed on the upper surface of the diffusion plate body, for dividing the light into a first circular polarized light and a second circular polarized light, wherein the first circular polarized light passes through the CLC layer, and the second circular polarized light is reflected;
a quarter-wave retardation, disposed on the CLC layer, for converting the first circular polarized light into a-linear polarized light; and
a reflection sheet, disposed below the light source, for reflecting the light and changing the polarization direction of the light.

21. The direct-type backlight module as claimed in claim 20, wherein the CLC layer is attached to the upper surface of the diffusion plate body.

22. The direct-type backlight module as claimed in claim 20, wherein the quarter-wave retardation is attached to the CLC layer.

23. The direct-type backlight module as claimed in claim 20, wherein the CLC layer is coated on the upper surface of the diffusion plate body.

24. The direct-type backlight module as claimed in claim 20, wherein the direct-type backlight module comprises at least three CLC layers.

25. The direct-type backlight module as claimed in claim 20, wherein the light source is a plurality of CCFLs.

26. The direct-type backlight module as claimed in claim 20, wherein the light source is a plurality of LEDs.
